(19) United States
(12) Patent Application Publication
(10) Pub. No.: US 2025/0094508 A1
(43) Pub. Date: Mar. 20, 2025

(54) DIGITAL COMPONENT PROVISION BASED ON CONTEXTUAL FEATURE DRIVEN AUDIENCE INTEREST PROFILES

(71) Applicant: Google LLC, Mountain View, CA (US)

(72) Inventors: Wei Huang, Kirkland, WA (US); Zhenyu Liu, San Jose, CA (US); Liang Wang, Bellevue, WA (US); Kumar Rishabh, Redmond, WA (US)

(21) Appl. No.: 18/577,448

(22) PCT Filed: Jan. 18, 2023
(86) PCT No.: PCT/US2023/011009

§ 371 Date: Jan. 8, 2024

(51) Int. Cl. G06F 16/9535; G06F 16/9537

(52) U.S. Cl. CPC G06F 16/9535; G06F 16/9537

(57) ABSTRACT

Methods, systems, and media comprising; obtaining, from a client device and during a browsing session conducted by a user, contextual features relating to context within the browsing session, wherein the contextual features do not include any personally-identifiable data; generating, using a trained contextual model and based on the contextual features, an audience interest profile, wherein the audience interest profile represents a prediction of affinity to one or more content categories, wherein the trained contextual model is trained using a set of historical contextual data aggregated from a plurality of prior browsing sessions and audience interest profiles that each represent an affinity to one or more content categories, and wherein the set of historical contextual data does not include any personally-identifiable data; identifying, based on the generated audience interest profile, a digital component for provision; and providing, for display on the client device and during the browsing session, the digital component.

### BACKGROUND

When a user of a client/user device navigates to a web site using a web browser, one or more digital components can be provided by a content server or content platform for display within the web page provided on the client device.

As used throughout this document, the phrase “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files. For example, the digital component may be content that is intended to supplement content of a video or other resource. More specifically, the digital component may include digital content that correlates to resource content (e.g., the digital component may relate to a topic that is the same as or otherwise related to the topic/content on a video). The provision of digital components can thus supplement, and generally enhance, the web page or application content.

### SUMMARY

This specification relates to digital component provisioning based on contextual feature driven audience interest profiles.

In general, one innovative aspect of the subject matter described in this specification can be embodied in methods including the operations of obtaining, from a client device and during a browsing session conducted by a user of the client device, multiple contextual features relating to context within which the browsing session is conducted, the multiple contextual features not including any personally-identifiable data of the user; generating, using a trained contextual model and based on the multiple contextual features, an audience interest profile applicable to the user of the client device, the trained contextual model being trained using training data including a set of historical contextual data aggregated from multiple prior browsing sessions and a corresponding set of labels indicating audience interest profiles that each represent an affinity of a particular audience interest segment to one or more content categories, and the set of historical contextual data not including any personally-identifiable data of users from the multiple prior browsing sessions; identifying, based on the generated audience interest profile, a digital component for provision on the client device; and providing, for display within a page displayed on the client device and during the browsing session, the digital component.

Other embodiments of this aspect include corresponding methods, apparatus, and computer programs, configured to perform the actions of the methods, encoded on computer storage devices. These and other embodiments can each optionally include one or more of the following features.

In some implementations, the methods can include training multiple models using a set of training data including sets of contextual features and label data including audience interest profiles corresponding to the sets of contextual features; determining that a performance of at least one of the models meets a set of evaluation criteria; and, in response to determining that the performance of the model meets the set of evaluation criteria, deploying one of the plurality of models as the trained model.

In some implementations, determining that a performance of the model meets a set of evaluation criteria can include applying one or more filters with a minimum preset relevance value, the preset relevance value being a numerical value based on a divergence between a predetermined mapping of two content categories.

In some implementations, the methods can include receiving, from a third party, a new content category and minimum relevance value; creating a new content category mapping based on the new content category; and establishing a new filter based on the new content category and minimum relevance value.

In some implementations the methods can include, in response to providing the digital component for display on the client device; obtaining, from the client device during the browsing session conducted by a user of the client device, subsequent contextual features related to the provided digital component; and modifying, using data relating to the subsequent contextual features, the audience interest profile of the user.

In some implementations, modifying the audience interest profile of the user can be conducted in real-time during the browsing session.

In some implementations, the data relating to the subsequent contextual features can be discarded after the termination of the browsing session on the client device.

Particular embodiments of the subject matter described in this specification can be implemented so as to realize one or more of the following advantages. The techniques described in this specification can realize processing and computing resource efficiencies for content servers that serve content to client devices. Conventional solutions require significant computer resource processing to identify digital components to serve to client devices. The computation intensive nature of these processes stems from having to ingest a significant number of signals obtained or derived from a client browsing session to identify digital components from among millions of available digital components. This ability to serve content becomes even more challenging when no browsing history or client device data is available, the absence of which precludes any refinement or narrowing of the types of digital components to provide to the client device.

In contrast, the contextual modeling techniques described here can be trained on contextually derived features from numerous prior browsing sessions and corresponding labels (e.g., affinity for particular types of content, age, gender, etc.) that can be merged together to generate audience interest profiles. These audience interest profiles allow more resource efficient component identification by removing processing burden from downstream content serving algorithms. For example, the techniques described herein enable a model to identify a particular audience interest profile that aligns or corresponds to a client device's browsing session (as informed by contextual features obtained during that session) and then using the identified audience interest profile to narrow the “pool” of digital components from which a digital component is selected for provision to the client device. Absent such pre-processing and audience profile identification, and further in the absence of any cookie-based data, the content identification algorithms would otherwise have to independently predict the digital components to serve to a client from a much larger available digital component “pool” (millions or billions of digital components as opposed to a fraction thereof), which can be a very resource intensive identification and selection process require multivariate analysis and processing.

Additionally, the techniques described in this specification can offer increased privacy protection for client devices and their associated operators. Conventional solutions to providing digital components included collecting and aggregating a particular device's content access and interaction data, which involved preserving collected data relating to the specific browsing sessions engaged in by the client device. Examples of such content access and interaction data (which may also be referred to herein as personal or personalized data can include records of specific digital components viewed by the user, user transactional data, or other data that can be used to identify a specific user). Contextual-based models allow the creation of profiles that may be representative of a particular group of users without collecting personal data that could be used to identify any individual user, such that the individual's privacy is protected while still serving content that the user wishes to see The methods and techniques described herein enable development of an audience interest profile based on contextualized and aggregated data received from numerous client devices-all without collecting data unique to or that can personally identify individual users of the numerous client devices. This in turn enables enhanced data security and privacy over a client device's sensitive data while obviating the need for collection and analysis of such sensitive data by entities other than those with access to the client device. Further still, any contextual data that is collected in the manner described herein, while not personally identifying, is nevertheless aggregated and processed in a privacy preserving manner, which further reduces the likelihood of even the contextual data from enabling identification of any particular client device that transmitted such data. In this manner, the techniques described herein offer significant improvements in network data security, which in turn enables improved privacy protections and facilitates compliance with data security and privacy-driven regulations and laws.

Additionally, contextual modeling can in some instances utilize contextual-based signals to provide contextually-relevant digital components instead of digital components that generally are provided based on content preference-based digital content provision. For example, for certain types of content (e.g., video content relating to fixing a washing machine), the contextual signals could indicate that the user has a present affinity to the subject matter of the particular content being viewed (e.g., washing machines)—even though the user-based profile might not have indicated an affinity for such subject matter—and in this regard, the contextual-based modeling can in some instances provide digital components with a higher degree of relevance and affinity than conventional solutions.

The details of one or more implementations are set forth in the accompanying drawings and the description, below. Other potential features and advantages of the disclosure will be apparent from the description and drawings, and from the claims.

### BRIEF DESCRIPTION OF THE DRAWINGS

FIG. 1 is an overview of an example system implementation.

FIG. 2 is a detailed view of an example contextual model development system.

FIG. 3 is an example process where a contextual model is developed.

FIG. 4 is a block diagram of an example computer system that can be used to perform operations described.

### DETAILED DESCRIPTION

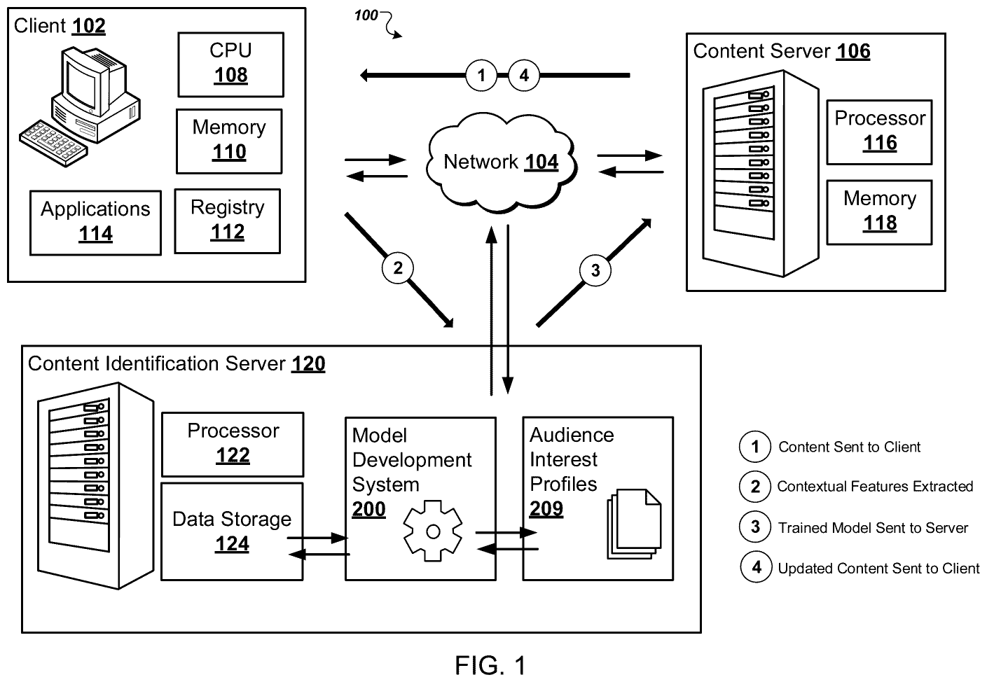

As summarized below, and described in greater detail with reference to FIGS. 1-4, this specification relates to digital component provisioning based on contextual feature driven audience interest profiles. In general, digital components can be served to client devices based on certain types of client device data (e.g., client device's identified preferences, prior content interaction history) and doing so, can be beneficial for consumers of the received content, which in turn facilitates improved user engagement with the content being displayed as well as the content platform on which such content is displayed. However, there may be some scenarios where such client device data is unavailable or is not provided by the client device's operators for any number of reasons, e.g., pursuant to data and privacy settings, or because certain regulations or laws preclude collection and/or transmission of such data.

The techniques described in this specification provide a contextual-based modeling framework that ingests contextual features received from a clients device to identify an audience interest profile that is correlated with the contextual features and which can then be used to identify and provide to the client device, one or more digital components corresponding to the identified audience interest profile. In some implementations, contextual features are received from numerous client devices and numerous browsing sessions, aggregated, and then used along with a set of corresponding labels, to train a contextual machine learning model over time. Examples of labels can include, but are not limited to, affinity to certain digital components, a designation that a client device has had or is likely to have a positive interaction with an item provided within, described by, or otherwise related to a digital component, or that the viewer of the browsing session belongs to a particular demographic (e.g., age, gender, etc.). Because labels can be designated preemptively, these options are representative examples and more solutions are possible. As used in this specification, “context” or “contextual” refers to the characteristics of a client browsing session. “Context” or “contextual data” does not refer to user information or personal data, nor is context used to specifically identify an individual user or develop a profile unique to that individual user. Some examples of context or contextual data can include the URL or web page accessed by the client device during a particular browsing session, a type of browser used to access the content, location of the client device, time at which the device, or any estimated or actual demographics provided by the user of the client device. Context or contextual data can also be a combination of the above, for example, a URL in combination with a client device type. Specific examples of context will be described later in this specification.

Then, during inference, real-time contextual features obtained during a client device's browsing session can be used as input to the contextual machine learning model, which then outputs an audience interest profile. After the conclusion of the browsing session, any real-time contextual features associated with the browsing session can be discarded in order to protect user privacy and satisfy government regulations. As used throughout this document, the phrase “audience interest profile” refers to an affinity of a particular audience segment to one or more content categories. For example, a “music lover” audience interest profile represents a segment of the population that is interested in music content (and can be further segmented into one or additional segments, e.g., classical music, jazz, etc.).

The audience interest profile output by the contextual machine learning model (and based on the input contextual features corresponding to the client device) is provided to a content server, which can use this audience interest profile to identify one or more digital components from a repository of digital components. In some implementations, the content provider can have a repository in which audience interest profiles correspond to one or more digital components types. The content provider can use the received audience interest profile to identify a digital component type associated with that profile and then identify one or more digital components corresponding to the identified digital component type. The identified digital component(s) are then provided to the client device where they can be provided for display as part of an ongoing browsing session.

The following disclosure provides additional details of the implementation and operation of the contextual machine learning model as part of a larger framework in which digital components are identified and provided to client devices based on contextual features obtained from those devices.

Further to the descriptions throughout this document, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

FIG. 1 is an overview of an example system implementation 100. The system 100 includes a plurality of clients 102, one or more networks 104, a plurality of content servers 106, and one or more content identification servers 120. The network 104 can include a local area network (LAN), a wide area network (WAN), the Internet, or a combination thereof. The network 104 can also include any type of wired and/or wireless network, satellite networks, cable networks, Wi-Fi networks, mobile communications networks (e.g., 3G, 4G, and so forth), or any combination thereof. The network 104 can utilize communications protocols, including packet-based and/or datagram-based protocols such as internet protocol (IP), transmission control protocol (TCP), user datagram protocol (UDP), or other types of protocols. The network 104 can further include a number of devices that facilitate network communications and/or form a hardware basis for the networks, such as switches, routers, gateways, access points, firewalls, base stations, repeaters or a combination thereof. The network 104 connects client devices 102, content servers 106, and content identifications servers 120.

In some implementations, client 102 is a personal computing device. Examples of such a personal computing device include personal computers, smartphones, PDAs, and other devices that are able to access and view content over an external network. In some implementations, client 102 includes a central processing unit (CPU) 108, a memory 110, a registry 112, and one or more applications 114. In some cases, applications 114 can include web browsing applications that allow the client device 102 to view content over an external network 104, for example, the Internet.

In some implementations, Internet content is stored on a plurality of content servers 106 in communication with the network 104. In some implementations, content server 106 includes one or more processors 116 and a memory device 118. In some cases, websites visited by the client device 102 store their content in the memory 118 of the plurality of content servers 106. In some cases, processors 116 within content servers 106 can decide which content to present to the client device 102. This content can be presented to the client device 102 through the client's web browsing applications 114. In some cases, the content stored on content servers 106 can be assigned identifiers (IDs), for example, features or labels that describe aspects of the content.

In some implementations, the system 100 can include one or more content identification servers 120 in communication with the network 104. In some cases, content identification server 120 is used to refine the process in which content servers 106 provide internet content to the client device 102, e.g., by identifying the digital components or the types of digital components to be provided to one or more client devices in response to content requests from the client device(s). In some implementations, content identification server 120 includes one or more processors 122, data storage 124, and a model development system 200 containing a plurality of audience interest profiles 209. In some cases, model development system 200 can use the context of the relationship between the client 102 and content servers 106 to adjust the operation of the processors 116 in the content servers 106 using the audience interest profiles 209.

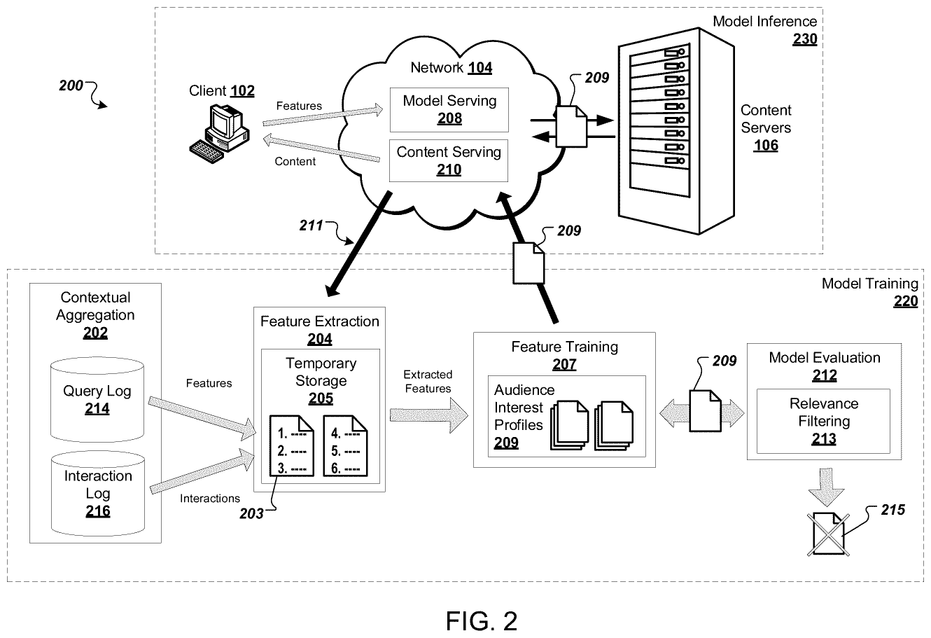

In some implementations, the model development system 200 can generate a trained contextual model that serves or provides an audience interest profile 209 to the content servers 106. In some cases, this contextual model can be trained initially with historical contextual data obtained from prior browser sessions (as aggregated from numerous consumer devices) to labels (examples of labels will be provided further with reference to FIG. 2). In some cases, prior to serving the audience interest profile 209 to the content servers 106, the model development system 200 can verify that the selected audience interest profile 209 meets certain relevancy requirements (as further described with reference to FIG. 2)

In some implementations, the content servers 106 can use the received audience interest profile 209 to determine digital components to serve to the client 102. In some cases, as the client 102 continues in the browsing session, the model development system 200 can receive additional contextual features that can be used to generate a new audience interest profile 209 that can be merged with one or more served audience interest profile 209 provided to the content servers 106. In this way, the served audience interest profile 209 can react in real-time to received contextual features during one or more browsing sessions, and become more robust or accurate over time. An example model development system 200 and process for generating an audience interest profile 209 is depicted and described with reference to FIG. 2.

FIG. 2 is a detailed view of an example contextual model development system 200 (as described with reference to FIG. 1). In some implementations, the model development system 200 can include a contextual aggregation process 202, a feature extraction process 204, a feature training process 207, a model serving process 208, a content serving process 210, and a model evaluation process 212. In some cases, the various processes contained within model development system 200 can be in communication over a network 104, for example, the Internet.

In some implementations, the model development system 200 can be divided into two main functional areas, model training 220 and model inference 230. In some implementations, model training 220 refers to the training of the model and generation of audience interest profiles based on logs of historical browsing data and corresponding interaction and aggregated audience data (e.g., aggregate demographics corresponding to the interacted-with content, affinity of population interacting with the content, positive interactions of the aggregate population with the content) of multiple client devices 102. In some cases, this browsing data and the corresponding interaction and aggregated audience data can be decomposed into contextual features 203 and corresponding labels, respectively. The model can be trained using these features and corresponding labels, with the goal of maximizing the model's objective function. In this manner, the model is trained to accept input contextual features and output a set of data or profiles, namely, an “affinity” profile, an “in-market” profile, and a “demographic” profile, which can then be merged into discrete audience interest profiles. Details and examples of these profiles will be discussed below. In some cases, once an initial audience interest profile 209 is generated, it is then evaluated before being served to the content servers 106.

In some implementations, model inference 230 refers to the gathering of additional real-time contextual features 203 after the model training and generation of audience interest profiles 209 (which are also provided to content servers 106 to facilitate content provision based on the received audience interest profiles) and identifying one or more audience profiles based on such input contextual features. In some cases, real-time contextual features 203 can be extracted during model inference 230 and can be logged in logs so that they can used as part of the model training process 220. In some cases, this process is executed in an ongoing manner as the client 102 browsing session continues.

In some implementations, both model training 220 and model inference 230 contain subordinate processes that will now be discussed in detail. Because the model development system 200 operates in a distributed computing environment, the various subordinate processes discussed below can be executed in many different physical arrangements.

In some implementations, contextual aggregation process 202 includes the collection of a plurality of contextual features determined during the browsing session of a client 102. In some cases, the model development system 200 can collect this information from the plurality of content servers 106 that hosted the viewed content. In some cases, these contextual features may be consolidated by the model development system 200 into a query log 214. As described above, “contextual” refers to the real-time characteristics of a client browsing session. In some cases, these characteristics can include features of the content, the content server, applications running on the client device, or generic information about the client that does not otherwise identify the user. In some implementations, these features include “query” features, “channel” features, and “content” features. Examples of query features include the time, client operating system, client browser application, client country location, and client geographic region. In some cases, a “channel” is a collection of digital components that share a common theme or correspond to a common content category.

In some cases, a channel can be associated with a particular content creator or content server 106. Examples of channel features include assigned channel ID, number of content channel views, number of content channel subscribers, and number of content channel views per unit of time. Examples of content features include assigned content ID, assigned content category ID, content product type, content label, content duration, number of views, number of “likes”, and number of “dislikes.”

In some implementations, an interaction log 216 can also be used in the contextual aggregation process 202. In some cases, the interaction log 216 is an aggregated and anonymized set of historical data that corresponds to the interactions of a plurality of clients 102 over a plurality of past browsing sessions. Interaction log 216 can be used to provide additional context to the browsing session, for example, which objects a certain number of clients 102 have interacted with over a period of time, as well as interaction trends between digital components.

In some implementations, feature extraction process 204 includes determining and temporarily storing relevant features 203 present in the query 214 and interaction 216 logs. For example, as a client views content over the internet, the feature extraction process 204 can retrieve contextual features 203 based on the browsing session and store them in a temporary storage 205. In some cases, the features 203 stored in temporary storage 205 can be used to train the contextual model or update the trained model such that more accurate audience interest profiles 209 can be merged with the initial audience interest profile 209 served to the content servers 106.

In some implementations, a feature training process 207 is used to train the contextual model to associate the extracted features 203 with corresponding labels and select the appropriate audience interest profile 209. In some cases, data on the correlation between extracted features 203 and labels determined during the feature training process 207 can be preserved for later use by the contextual model for generating initial audience interest profiles 209.

In some implementations, the feature training process 207 can create multiple profiles that together comprise the audience interest profile 209. For example, the feature training process 207 can create an “affinity” profile, an “in-market profile, and a “demographic” profile and merge these three profiles into one consolidated audience interest profile 209 that correlates to the combined interests of its constituents. In some cases, after serving the initial audience interest profile 209, the feature training process 207 can continue to refine the association of features 203 and labels such that updated audience interest profiles 209 can be merged with the initial audience interest profile 209 served to the content servers 106.

For example, after serving the audience interest profile 209, the feature training process 207 can detect an increased amount of features 203 that correspond to a label for a digital component channel suited for users that are “in the market” for a new car. In this example, the feature training process 207 can update the trained contextual model to provide a new “in market” audience interest profile 209 to merge with the audience interest profile 209 in use at the content servers 106. Following the merger of audience interest profiles 209, content servers 106 would begin to serve more digital components to the client 102, which based on obtained contextual features may be associated by the model to this updated audience interest profile.

In some implementations, a vertical mapping process can be utilized to group or merge audience interest profiles. As used in this specification, a “vertical” refers to a category or grouping of a set of digital components and can include, e.g., verticals such as shoes, sports, news, etc. In some cases, a vertical can be assigned a numerical relevancy value, for example, a decimal between “0” and “1”. Each URL, video or another content item is mapped/matched to one or more verticals. For example, a URL for xyz_brand.com/shoes could be matched to the example verticals of shoes and sports.

In some cases, a vertical can be compared to, or affect, the relevancy of another vertical. For example, if a vertical is established for “music lovers”, the feature training process 207 may decide to adjust the relevancy of the “music lover” vertical if it similarly adjusts the “classical music” vertical. In some cases, like verticals can also be grouped together in one consolidated unit with an associated relevancy value. In some cases, “mappings” that delineate the similarities between the verticals can be provided to the feature training process 207 directly. In some cases, this vertical correlation or consolidated vertical correlation can be used to infer the affinity of the client 102 to a particular set of digital components defined by a vertical. This affinity can then be used by the feature training process 207 to adjust the audience interest profile 209 accordingly.

In some implementations, verticals may also be created by a third party that wishes to establish a particular content category with a specified relevancy requirement. In some cases, the process of establishing new verticals may be conducted over network 104 by the one or more content servers 106. In some cases, the feature training process 207 can group this third party vertical with an established vertical, or vertical group. Alternatively, is also possible that the feature training process 207 forms a new vertical group based on the new third party vertical.

In some implementations, the model development system 200 includes a model evaluation process 212. In some cases, once an audience interest profile 209 is generated, the audience interest profile 209 can be evaluated against a set of criteria to ensure the generated audience interest profile meets certain predefined performance parameters. In some implementations, this model evaluation process 212 can prevent inaccurate audience interest profiles 209 from being served. In some cases, the model evaluation process 212 includes one or more relevance filters 213. In some cases, these relevance filters 213 can specify a predefined relevance value that must be met in order for an audience interest profile 209 to be served. In some cases, this preset relevancy value can be set by a third party. In some cases, audience interest profiles 209 that do not meet the required relevancy values are removed 215 from the model development system 200.

In some implementations, audience interest profiles 209 can also be evaluated against standard user demographic approximations for the geographic region of the client 102. In some implementations, these demographic approximations can be obtained from a third party. In some cases, demographic approximations are informed by government census information that indicates gender and age approximations for geographic regions that can be matched to the geographic region of the client 102. In some cases, when analyzing the generated audience interest profile 209, the model evaluation process 212 can detect that an audience interest profile 209 has a substantial divergence from the associated demographic approximation for the geographic region. As one example, the model evaluation process 212 can remove, reject, or otherwise disregard 215 the generated audience interest profile 209 if it differs from the demographic approximation by more than a threshold amount, for example, if the audience interest profile 209 indicates a fifty percent increase in male viewership over the demographic approximation for the male gender.

In some implementations, the relevancy of a vertical to other verticals in the audience interest profile 209 can be measured. In some cases, this can be referred to as a “semantic” relevance. For example, if a “music lover” audience interest profile is generated based on contextual features that are otherwise associated with or correspond to different audience interest profiles (e.g., those corresponding to sports news content), the audience interest profile 209 can be rejected by the model evaluation process 212 because of the lack of semantic relevant between the generated audience interest profile (e.g., music lover) to other audience interest profiles also corresponding or associated with similar contextual features (e.g., sports or new content).

In some implementations, after the contextual model is trained, at least one of the audience interest profile 209 is selected by the contextual model (e.g., if it meets the above-described evaluation process) and served to the one or more content servers 106 in the model serving process 208. In some cases, model serving process 208 can be executed by the one or more content servers 106 to inform future content serving decisions.

In some implementations, the audience interest profile 209 is then used in a content serving process 210. In some cases, this process can be executed by the one or more content servers 106 such that the served content is transmitted to the client device 102 over network 104. For example, a content server 106 can have a repository that stores a correlation between different audience interest profiles and corresponding digital component types (and may further have a correlation between component types and digital components of that component type). In such scenarios, the content server 106 can use the received audience interest profile 209 identified by the contextual model and use the received interest profile to identify, from the repository, one or more digital component types. The content server 106 can then identify one or more digital components corresponding to the identified digital component type(s) and provide the same to the client device-which then can be displayed during an ongoing browsing session (e.g., within a web page) at the client device.

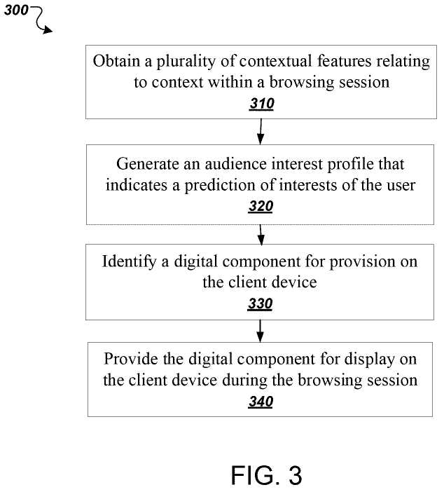

FIG. 3 is an example process 300 where a contextual model and audience interest profile are developed. Operations of the process 300 are illustratively executed by a system, e.g., a system as shown in FIGS. 1 and 2. Operations of the process 300 can also be implemented as instructions stored on one or more computer readable media, which may be non-transitory, and execution of the instructions by one or more data processing apparatus can cause the one or more data processing apparatus to perform the operations of the process 300.

In some implementations, the process 300 includes obtaining, from a client device and during a browsing session conducted by a user of the client device, a plurality of contextual features relating to context within which the browsing session is conducted 310 (as described with reference to FIGS. 1-2). In some cases, obtaining contextual features can be performed in an ongoing manner after an initial audience interest profile has been served to the content servers 106. As described here, the contextual features include data that do not include any personally-identifiable data of the device user.

In some implementations, the process 300 includes generating, using a trained contextual model and based on the plurality of contextual features, an audience interest profile applicable to the user of the client device 320 (as described with reference to FIGS. 1-2). In some cases, the trained contextual model can be trained using training data including a set of historical contextual data aggregated from a plurality of prior browsing sessions and a corresponding set of labels indicating audience interest profiles that each represent an affinity of a particular audience interest segment to one or more content categories.

In some implementations, the process 300 includes identifying, based on the generated audience interest profile, a digital component for provision on the client device 330 (as described with reference to FIGS. 1-2). In some cases, the identifying of a digital component can be performed by the content servers 106 after receiving an audience interest profile 209 from the content identification server 120.

In some implementations, the process 300 includes providing, for display within a page displayed on the client device 102 and during the browsing session, the digital component 340 (as described with reference to FIGS. 1-2). In some cases, the digital component can be transmitted to the client 102 by the content server 106 over a network 104. The client 102 may request a digital component from the content server 106, or the content server 106 may provide the digital component in response to the client 102 performing an action, for example, navigating to a webpage.

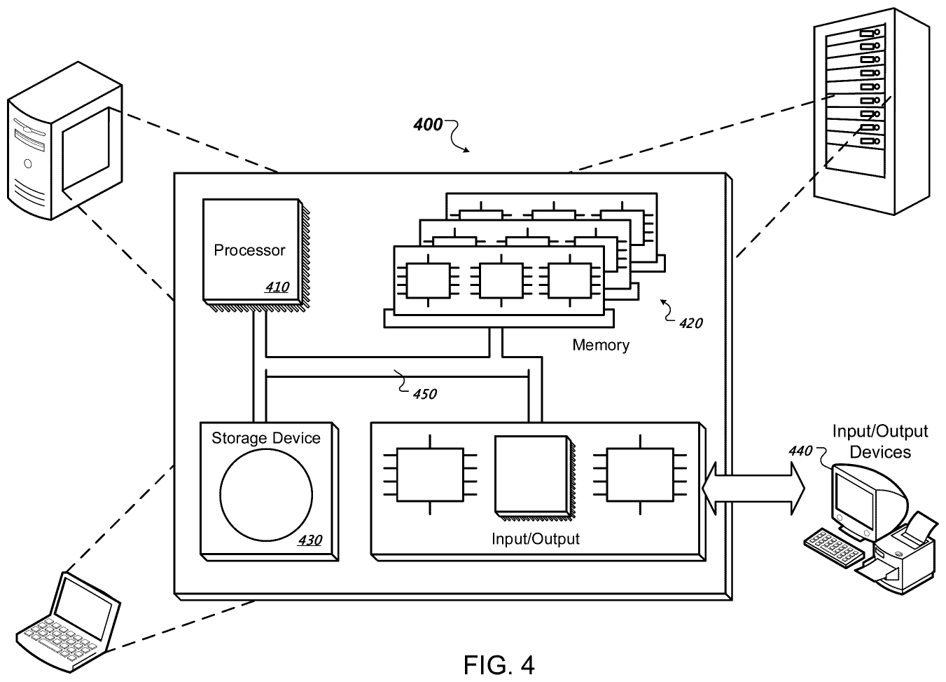

FIG. 4 is block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In some implementations, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In some implementations, the memory 420 is a volatile memory unit. In another implementation, the memory 420 is a non-volatile memory unit.

The storage device 430 is capable of providing mass storage for the system 400. In some implementations, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In some implementations, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to peripheral devices, e.g., keyboard, printer and display devices. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

What is claimed is:

1. A computer-implemented method comprising:
obtaining, from a client device and during a browsing session conducted by a user of the client device, a plurality of contextual features relating to context within which the browsing session is conducted, wherein the plurality of contextual features do not include any personally-identifiable data of the user;
generating, using a trained contextual model and based on the plurality of contextual features, an audience interest profile applicable to the user of the client device,
wherein the trained contextual model is trained using training data including a set of historical contextual data aggregated from a plurality of prior browsing sessions and a corresponding set of labels indicating audience interest profiles that each represent an affinity of a particular audience interest segment to one or more content categories, and
wherein the set of historical contextual data does not include any personally-identifiable data of users from the plurality of prior browsing sessions;
identifying, based on the generated audience interest profile, a digital component for provision on the client device; and
providing, for display within a page displayed on the client device and during the browsing session, the digital component.

2. The computer-implemented method of claim 1, further comprising:
training a plurality of models using a set of training data including sets of contextual features and label data including audience interest profiles corresponding to the sets of contextual features;
determining that a performance of at least one of the models meets a set of evaluation criteria;
in response to determining that the performance of the model meets the set of evaluation criteria, deploying one of the plurality of models as the trained model.

3. The computer-implemented method of claim 2, wherein determining that a performance of the model meets a set of evaluation criteria further comprises applying one or more filters with a minimum preset relevance value, wherein the preset relevance value is numerical value based on a divergence between a predetermined mapping of two content categories.

4. The computer-implemented method of claim 3, further comprising:
receiving, from a third party, a new content category and minimum relevance value;
creating a new content category mapping based on the new content category; and
establishing a new filter based on the new content category and minimum relevance value.

5. The computer-implemented method of claim 1, further comprising:
in response to providing the digital component for display on the client device;
obtaining, from the client device during the browsing session conducted by a user of the client device, subsequent contextual features related to the provided digital component; and
modifying, using data relating to the subsequent contextual features, the audience interest profile of the user.

6. The computer-implemented method of claim 5, wherein modifying the audience interest profile of the user is conducted in real-time during the browsing session.

7. The computer-implemented method of claim 5, wherein the data relating to the subsequent contextual features is discarded after the termination of the browsing session on the client device.

8. A system comprising:
one or more computers and one or more storage devices storing instructions that are operable, when executed by the one or more computers, to cause the one or more computers to perform operations comprising:
obtaining, from a client device and during a browsing session conducted by a user of the client device, a plurality of contextual features relating to context within which the browsing session is conducted, wherein the plurality of contextual features do not include any personally-identifiable data of the user;
generating, using a trained contextual model and based on the plurality of contextual features, an audience interest profile applicable to the user of the client device, wherein the audience interest profile,
wherein the trained contextual model is trained using training data including a set of historical contextual data aggregated from a plurality of prior browsing sessions and a corresponding set of labels indicating audience interest profiles that each represent an affinity of a particular audience interest segment to one or more content categories, and
wherein the set of historical contextual data does not include any personally-identifiable data of users from the plurality of prior browsing sessions;
identifying, based on the generated audience interest profile, a digital component for provision on the client device; and
providing, for display within a page displayed on the client device and during the browsing session, the digital component.

9. The system of claim 8, further comprising:
training a plurality of models using a set of training data including sets of contextual features and label data including audience interest profiles corresponding to the sets of contextual features;
determining that a performance of at least one of the models meets a set of evaluation criteria;
in response to determining that the performance of the model meets the set of evaluation criteria, deploying one of the plurality of models as the trained model.

10. The system of claim 9, wherein determining that a performance of the model meets a set of evaluation criteria further comprises applying one or more filters with a minimum preset relevance value, wherein the preset relevance value is numerical value based on a divergence between a predetermined mapping of two content categories.

11. The system of claim 10, further comprising:
receiving, from a third party, a new content category and minimum relevance value;
creating a new content category mapping based on the new content category; and
establishing a new filter based on the new content category and minimum relevance value.

12. The system of claim 8, further comprising:
in response to providing the digital component for display on the client device;
obtaining, from the client device during the browsing session conducted by a user of the client device, subsequent contextual features related to the provided digital component; and
modifying, using data relating to the subsequent contextual features, the audience interest profile of the user.

13. The system of claim 12, wherein modifying the audience interest profile of the user is conducted in real-time during the browsing session.

14. The system of claim 12, wherein the data relating to the subsequent contextual features is discarded after the termination of the browsing session on the client device.

15. One or more non-transitory computer storage media encoded with computer program instructions that when executed by one or more computers cause the one or more computers to perform operations comprising:
obtaining, from a client device and during a browsing session conducted by a user of the client device, a plurality of contextual features relating to context within which the browsing session is conducted, wherein the plurality of contextual features do not include any personally-identifiable data of the user;
generating, using a trained contextual model and based on the plurality of contextual features, an audience interest profile applicable to the user of the client device, wherein the audience interest profile,
wherein the trained contextual model is trained using training data including a set of historical contextual data aggregated from a plurality of prior browsing sessions and a corresponding set of labels indicating audience interest profiles that each represent an affinity of a particular audience interest segment to one or more content categories, and
wherein the set of historical contextual data does not include any personally-identifiable data of users from the plurality of prior browsing sessions;
identifying, based on the generated audience interest profile, a digital component for provision on the client device; and
providing, for display within a page displayed on the client device and during the browsing session, the digital component.

16. The media of claim 15, further comprising:
training a plurality of models using a set of training data including sets of contextual features and label data including audience interest profiles corresponding to the sets of contextual features;
determining that a performance of at least one of the models meets a set of evaluation criteria;
in response to determining that the performance of the model meets the set of evaluation criteria, deploying one of the plurality of models as the trained model.

17. The media of claim 16, wherein determining that a performance of the model meets a set of evaluation criteria further comprises applying one or more filters with a minimum preset relevance value, wherein the preset relevance value is numerical value based on a divergence between a predetermined mapping of two content categories.

18. The media of claim 17, further comprising:
receiving, from a third party, a new content category and minimum relevance value;
creating a new content category mapping based on the new content category; and
establishing a new filter based on the new content category and minimum relevance value.

19. The media of claim 15, further comprising:
in response to providing the digital component for display on the client device;
obtaining, from the client device during the browsing session conducted by a user of the client device, subsequent contextual features related to the provided digital component; and
modifying, using data relating to the subsequent contextual features, the audience interest profile of the user.

20. The media of claim 19, wherein modifying the audience interest profile of the user is conducted in real-time during the browsing session.
